(19) United States
(12) Patent Application Publication
(10) Pub. No.: US 2014/0060125 A1
(43) Pub. Date: Mar. 6, 2014

(54) LOCKING ASSEMBLY FOR A PORTABLE ELECTRON DEVICE

(71) Applicant: JIN TAY INDUSTRIES CO., LTD., New Taipei (TW)

(72) Inventor: Kuo-Tsung YANG, Taipei (TW)

(73) Assignee: Jin Tay Industries Co., Ltd., New Taipei (TW)

(21) Appl. No.: 13/677,669

(22) Filed: Nov. 15, 2012

(30) Foreign Application Priority Data
Aug. 31, 2012 (TW) 101131656

(51) Int. Cl. E05B 73/00

(52) U.S. Cl. CPC E05B 73/0082
USPC 70/15

(57) ABSTRACT

A locking assembly for a portable electron device has a main frame, an inserting element and a lock. The main frame has a first clamping segment, a second clamping segment, a mounting segment and a limiting segment. The mounting segment is formed on and protrudes from the first clamping segment. The limiting hole is formed through the mounting segment and the first clamping segment. The inserting element is mounted through the limiting hole of the main frame. The lock is mounted around the mounting segment and the inserting element and has a body, a controlling element and an extending element. The body is mounted around the mounting segment. The controlling element is movably connected to the body. The extending element is securely connected to the body opposite to the controlling element.

### BACKGROUND OF THE INVENTION

1. Field of the Invention

The present invention relates to a locking assembly, and more particularly to a locking assembly for a portable electron device to lock the electron device at a specific position to prevent the portable electron device from being stolen when the portable electron device is not taken with a user.

2. Description of Related Art

With the evolution of technology, more and more portable electron devices such as mobile phones or tablet computers are produced and have multi-functions and a high price.

However, the portable electron devices can be taken with the user, the portable electron device has a certain volume and cannot be taken conveniently with the user when the user temporarily leaves. For example, when the user uses a tablet computer in a coffee shop or a library and wants to take meals or to toilet without tanking with the tablet computer conveniently. Then, the tablet computer may be stolen when the tablet computer is not taken with the user.

To overcome the shortcomings, the present invention provides a locking assembly for a portable electron device to mitigate or obviate the aforementioned problems.

### SUMMARY OF THE INVENTION

The primary objective of the present invention is to provide a locking assembly for a portable electron device to lock the electron device at a specific position to prevent the portable electron device from being stolen when the portable electron device is not taken with a user.

The locking assembly for a portable electron device in accordance with the present invention has a main frame, an inserting element and a lock. The main frame has a first clamping segment, a second clamping segment, a mounting segment and a limiting segment. The mounting segment is formed on and protrudes from the first clamping segment. The limiting hole is formed through the mounting segment and the first clamping segment. The inserting element is mounted through the limiting hole of the main frame. The lock is mounted around the mounting segment and the inserting element and has a body, a controlling element and an extending element. The body is mounted around the mounting segment. The controlling element is movably connected to the body. The extending element is securely connected to the body opposite to the controlling element.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a locking assembly for a portable electron device in accordance with the present invention connecting with a portable electron device;

FIG. 2 is an enlarged and exploded perspective view of the locking assembly for a portable electron device in FIG. 1;

FIG. 3 is an enlarged side view in partial section of the locking assembly in FIG. 1 connecting with a portable electron device;

FIG. 4 is an enlarged perspective view of a lock of the locking assembly for a portable electron device in FIG. 1;

FIG. 5 is a side view in partial section of a lock of the locking assembly in FIG. 4;

FIG. 6 is an operational side view in partial section of a lock of the locking assembly in FIG. 4;

FIG. 7 is an operational side view of the locking assembly in FIG. 1 being mounted between a post and a portable electron device;

FIG. 8 is an exploded perspective view of a second embodiment of a locking assembly for a portable electron device in accordance with the present invention; and

FIG. 9 is an enlarged side view in partial section of the locking assembly in FIG. 8 connecting with a portable electron device.

### DETAILED DESCRIPTION OF THE PREFERRED EMBODIMENT

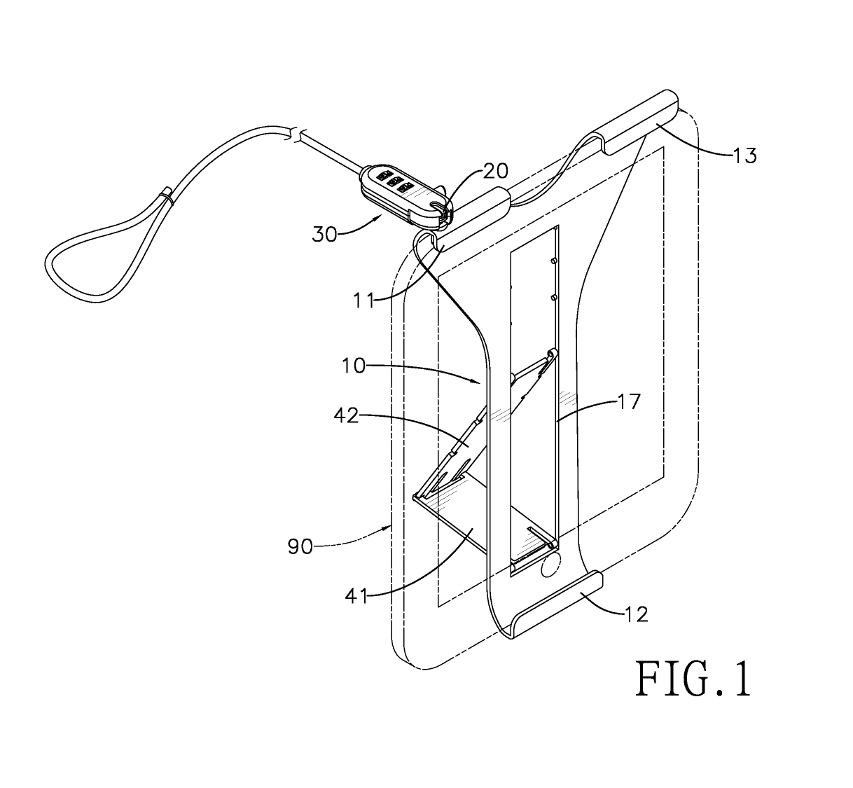

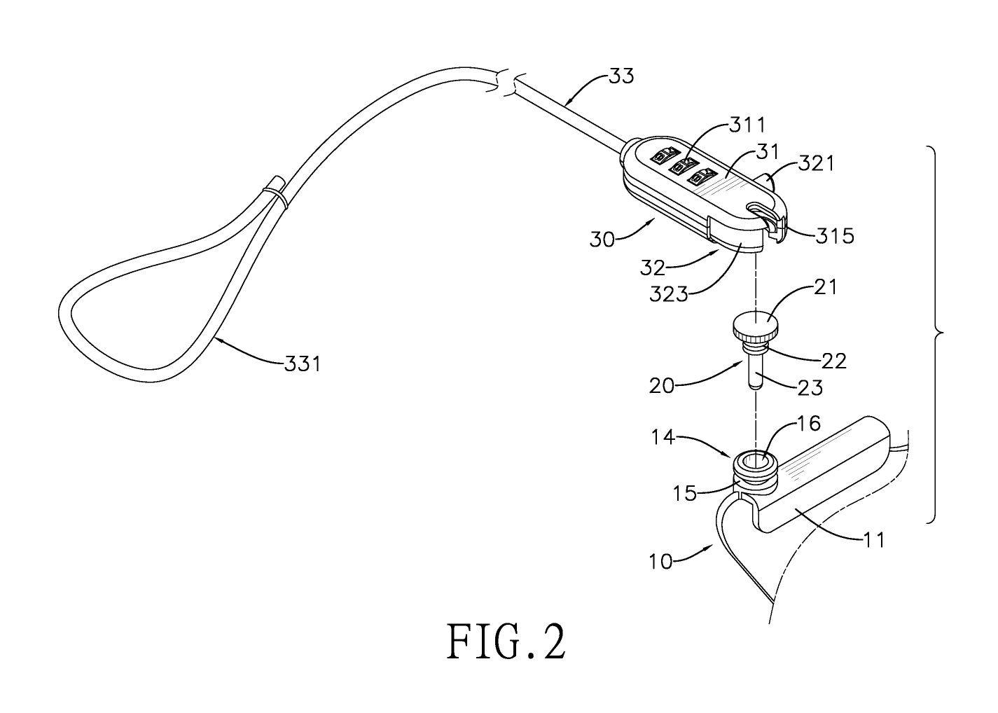

With reference to FIGS. 1 and 2, a first embodiment of a locking assembly for a portable electron device in accordance with the present invention has a main frame 10, an inserting element 20 and a lock 30.

With further reference to FIGS. 1 to 3, the main frame 10 may be Y-shaped and has a proximal end, a distal end, a first clamping segment 11, a second clamping segment 12, a third clamping segment 13, a mounting segment 14, a limiting hole 16, an elongate hole 17, a base board 41 and a supporting board 42.

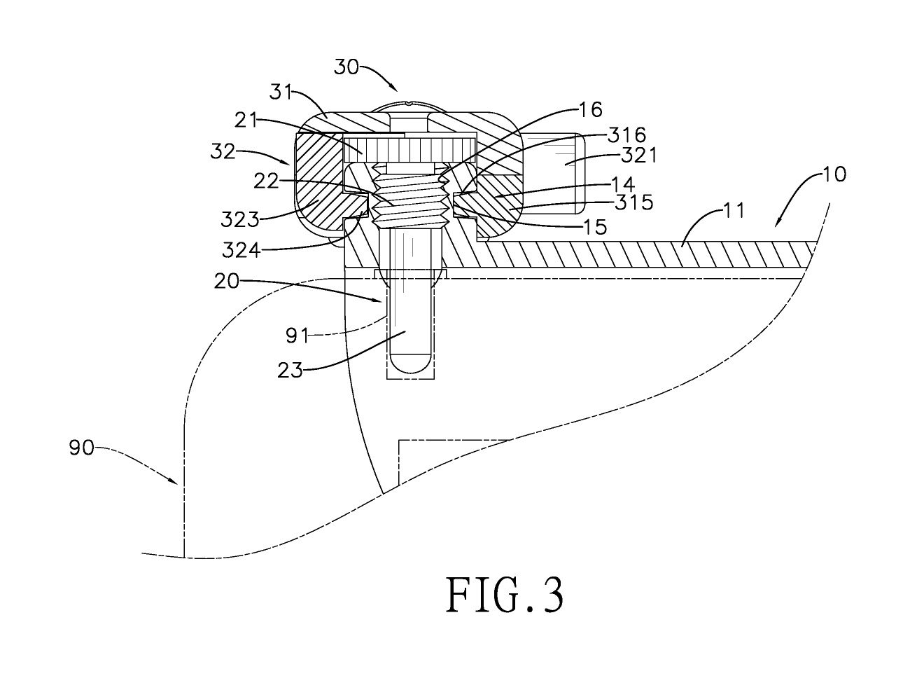

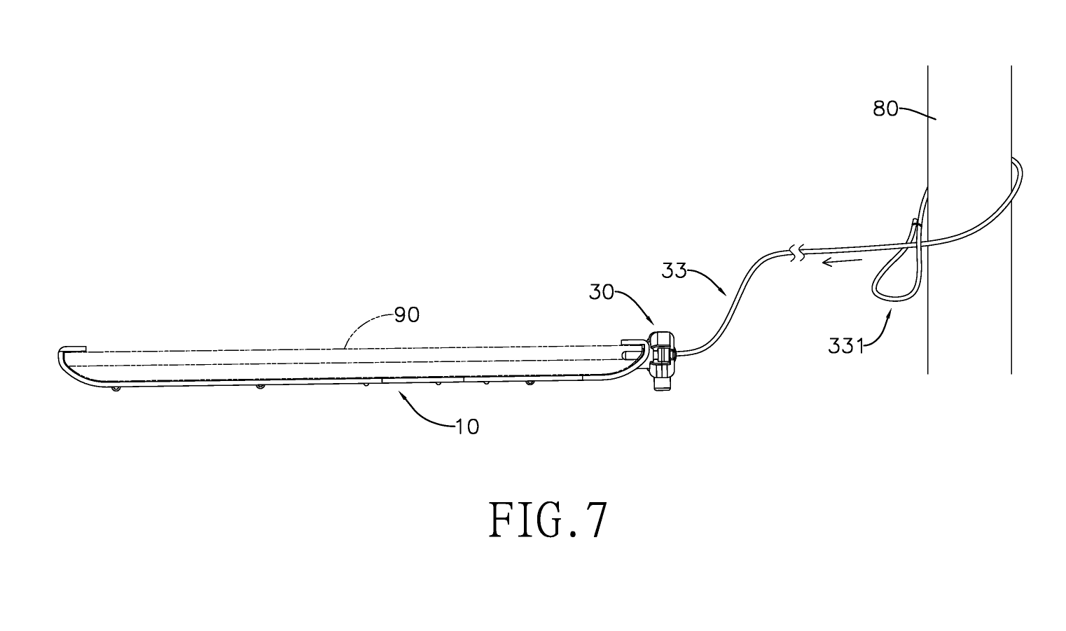

The first clamping segment 11 and the third clamping segment 13 are curvedly formed on the proximal end of the main frame 10 and each one of the clamping segments 11, 13 has an opening. The second clamping segment 12 is curvedly formed on the distal end of the main frame 10, parallels the first clamping segment 11 and the third clamping segment 13 and has an opening facing the openings of the first clamping segment 11 and the third clamping segment 13. Then, a portable electron device 90 can be mounted in the main frame 10 by inserting the portable electron device 90 between the clamping segments 11, 12, 13 as shown in FIGS. 3 and 7.

The mounting segment 14 may be cylindrical, is formed on and protrudes from the proximal end of the first clamping segment 11 and has an external surface and a recess 15 formed around the external surface of the mounting segment 14. The limiting hole 16 may be threaded and is formed through the mounting segment 14 and the first clamping segment 11 of the main frame 10. When the portable electron device 90 mounted in the main frame 10, an earphone hole 91 of the portable electron device 90 aligns with the limiting hole 16 of the main frame 10 as shown in FIG. 3.

The elongated hole 17 is formed through the main frame 10 between the clamping segments 11, 12, 13. The base board 41 is pivotally connected to the main frame 10 in the elongated hole 17. The supporting board 42 is pivotally connected to the base board 41 and is selectively connected to the main frame 10 in the elongate hole 17. When an angle between the base board 41 and the supporting board is 180 degrees, the base board 41 and the supporting board 42 are mounted in the elongate hole 17. When the angle between the base board 41 and the supporting board 42 is smaller than 180 degrees, the boards 41, 42 and the main frame 10 can provide a triangular structure, and this can hold the portable electron device 90 at a specific angle.

The inserting element 20 may be screwed with the limiting hole 16 of the main frame 10, is mounted through the limiting hole 16 of the main frame 10 and is mounted into the earphone 91 of the portable electron device 90. The inserting element 20 has a top end, a bottom end, an external surface, a head segment 21, a threaded segment 22 and a shaft segment 23. The head segment 21 is formed on the top end of the inserting element 20 and abuts a top of the mounting segment 14 of the main frame 10. The threaded segment 22 is formed around the external surface of the inserting element 20 and is screwed with the limiting hole 16 of the main frame 10 to connect the inserting element 20 with the main frame 10. The shaft segment 23 is formed on and protrudes from the bottom end of the inserting element 20, extends through the limiting hole 16 and is mounted in the earphone 91 of the portable electron device 90 via the first clamping segment 11 of the main frame 10 to prevent the portable electron device 90 from moving transversally relative to the main frame 10. As the above-mentioned statement, the portable electron device 90 only can be moved transversally relative to the main frame 10 by the clamping segments 11, 12, 13. When the inserting element 20 is screwed with and mounted through the limiting hole 16 of the main frame 10 and is mounted in the earphone 91 of the portable electron device 90, the portable electron device 90 is securely connected to the main frame 10 without moving relative to the main frame 10.

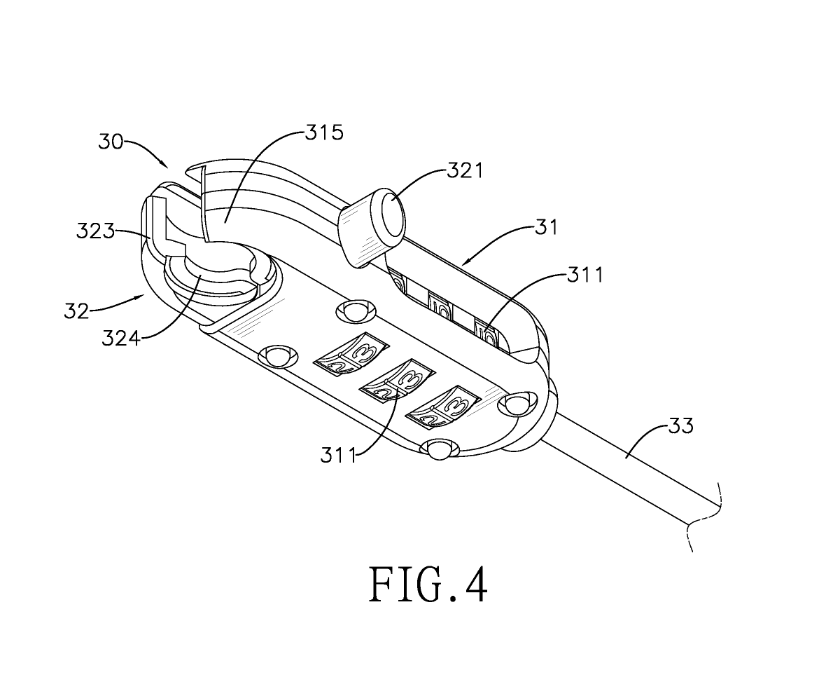

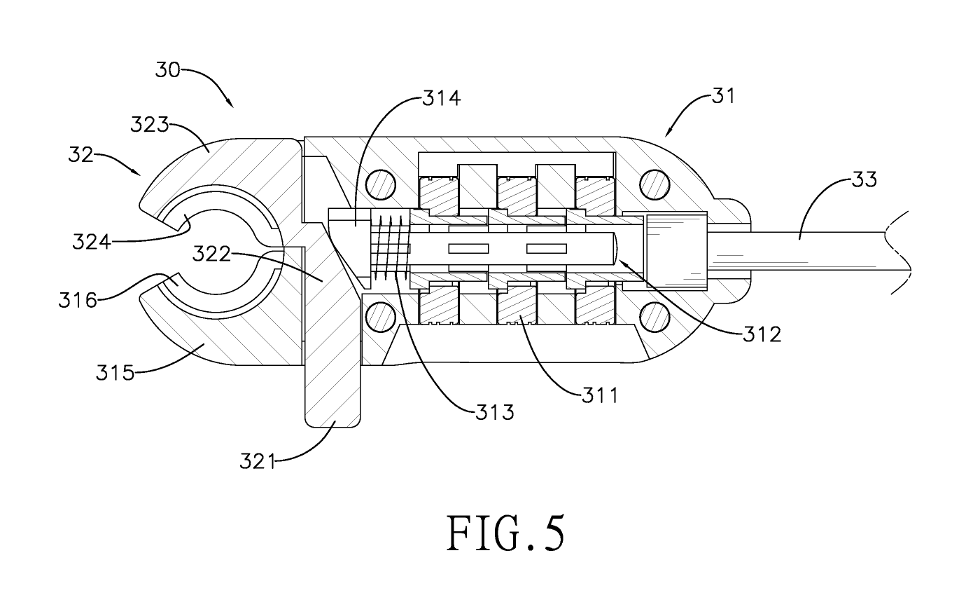

With reference to FIGS. 2 to 5, the lock 30 may be a combination lock, is connected to the inserting element 20 and has a body 31, a controlling element 32 and an extending element. The body 31 is mounted around the mounting segment 14 and has a clamping end, a cord end, multiple rotating wheels 311, a spindle 312, a spring 313 and a clamping arm 315. The rotating wheels 311 are rotatably mounted in the body 31 at intervals between the ends of the body 31, and each rotating wheel 311 has an external surface, multiple number marks and a non-circular hole. The external surface of each one of the rotating wheels 311 extends out of the body 31. The number marks are formed on the external surface of the rotating wheel 311 at intervals. The non-circular hole is axially formed through the rotating wheel 311. Preferably, the non-circular hole of each one of the rotating wheel 311 is formed by a jacket.

The spindle 312 is mounted through the non-circular holes of the rotating wheels 311 and has an external surface, an inner end, an outer end, multiple protrusions and a pushing block 314. The inner end of the spindle 312 extends through the non-circular holes of the rotating wheels 311. The protrusions are formed on the external surface of the spindle 312 at intervals and respectively have shapes corresponding to the shapes of the non-circular holes of the rotating wheels 311. The pushing block 314 is formed on and protrudes from the outer end of the spindle 312 near the clamping end of the body 31 and has an outer side and an inclined plane formed on the outer side of the pushing block 314. The spring 313 is mounted around the spindle 312 between the pushing block 314 and one of the rotating wheels 311 to push the spindle 312 to move relative to the body 31.

The clamping arm 315 is may curved, is formed on and protrudes from the clamping end of the body 31 to mount around the mounting segment 14 of the main frame 10 and has an inner side and an engaging flange 316. The engaging flange 316 is formed on and protrudes from the inner side of the clamping arm 315 and selectively engages the recess 15 of the mounting segment 14 of the main frame 10.

The controlling element 32 is linear movably connected to the clamping end of body 31 and has an operating segment 321, an abutting segment 322 and a clamping segment 323. The operating segment 321 pressably extends out of a side face of the body 31 near the clamping arm 315 and has an inner end mounted in the body 31 near the pushing block 314 of the spindle 312. The abutting segment 322 is formed on and protrudes from the inner end of the operating segment 321 and has a side face and a slant face abutting the inclined plane of the pushing block 314 to push the spindle 312 to move relative to the rotating wheels 311.

The clamping segment 323 is formed on and protrudes from the side face of the abutting segment 322, extends out of the clamping end of the body 31 and faces and corresponding to the clamping arm 315 of the body 31. The clamping segment 323 has an inner side and an engaging flange 324. The engaging flange 324 is formed on and protrudes from the inner side of the clamping segment 323 and selectively engages the recess 15 of the mounting segment 14 of the main frame 10. The clamping arm 315 and the clamping segment 323 are formed a clamping opening at the clamping end of the body 31. Then, the body 31 of the lock 30 can be mounted around the mounting segment 14 by the engaging flanges 316, 324 of the clamping arm 315 and the clamping segment 322 of the controlling element 32 engaging the recess 15 of the mounting segment 14.

The extending element may be a cord 33, is securely connected to the body 31 opposite to the controlling element 32 and has a connecting end, a mounting end and a ring segment 331. The connecting end of the cord 33 is securely connected to the cord end of the body 31. The ring segment 331 is formed on the mounting end of the cord 33.

With further reference to FIGS. 1 and 3 to 5, when any one of the rotating wheels 311 is not rotated at a right position corresponding to secret code of the lock 30, the lock 30 is set in a lock condition and the non-circular holes of the rotating wheels 311 will respectively abut the protrusions of the spindle 312. Then, the spindle 312 cannot be moved relative to the body 31, and the controlling element 32 cannot be pressed to move relative to the body 31 by the abutment between the inclined plane of the pushing block 314 and the slant face of the abutting segment 322. Consequently, the clamping segment 323 of the controlling element 32 cannot be moved relative to the clamping arm 315 of the body 31.

With further reference to FIG. 3, when the lock 30 is set in a lock condition, the clamping opening that is formed by the clamping segment 323 of the controlling element 32 and the clamping arm 315 of the body 31 is mounted around the mounting segment 14 of the main frame 10 and the head segment 21 of the inserting element 20. In addition, the engaging flanges 316, 324 of the clamping arm 315 and the clamping segment 323 engage the recess 15 of the mounting segment 14 of the main frame 10. Then, the lock 30 is securely connected to the main frame 10 by the engagement between the recess 15 of the mounting segment 14 and the engaging flanges 315, 324 of the clamping arm 315 and the clamping segment 323. Furthermore, the clamping arm 315 and the clamping segment 323 are mounted over the head segment 21 of the inserting element 20 and this can prevent the inserting element 20 separating upwardly from the mounting segment 14 of the main frame 10 and the earphone 91 of the portable electron device 90. Consequently, the portable electron device 90 can be securely mounted in the main frame 10 without moving by the inserting element 20 and the lock 30.

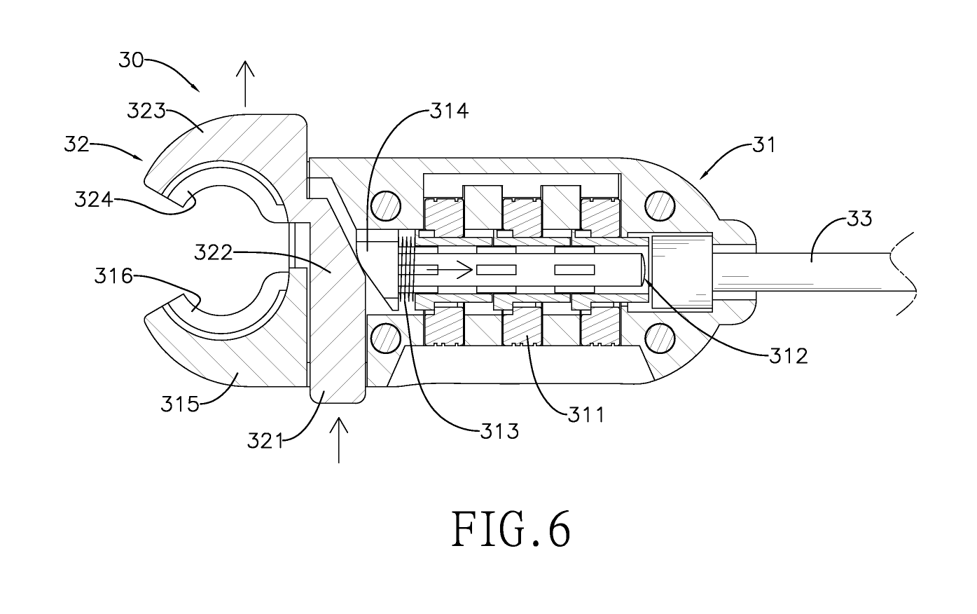

With reference to FIGS. 1, 3 and 6, when the rotating wheels 311 are rotated at the right position corresponding to secret code of the lock 30 to unlock the lock 30, the non-circular holes of the rotating wheels 311 are mounted around the protrusions of the spindle 312 without abutting the protrusions. Then, the spindle 312 can be moved relative to the rotating wheels 311 in the body 31. When the spindle 312 can be moved relative to the rotating wheels 311, the operating segment 321 of the controlling element 32 can be pressed to enable the abutting segment 322 to push the pushing block 314 of the spindle 312 by the abutment between the inclined plane of the pushing block 314 and the slant face of the abutting segment 322 and to compress the spring 313 between the pushing block 314 and one of the rotating wheels 311.

Furthermore, when the operating segment 321 of the controlling element 32 can be pressed relative to the body 31, the clamping segment 323 of the controlling element 32 can be disengaged from the head segment 21 of the inserting element 20 and the mounting segment 14 of the main frame 10. Then, the engaging flanges 316, 324 of the clamping arm 315 and the clamping segment 323 can be separated from the recess 15 of the mounting segment 14 to remove the lock 30 from the main frame 10, and the inserting element 20 can be removed from the mounting segment 14 of the main frame 10 and the earphone hole 91 of the portable electron device 90. When the lock 30 and the inserting element 20 are removed from the main frame 10 and the portable electron device 90, the portable electron device 90 can be moved transversally relative to the main frame 10 between the clamping segments 11, 12, 13 or can be separated from the main frame 10.

With reference to FIGS. 1, 3, 4 and 7, the lock 30 is set in a lock condition or an un-lock condition by rotating the rotating wheels 311 relative to the body 31. When a user wants to fix the portable electron device 90 with a post 80 that is securely mounted on a wall, first the portable electron device 90 is mounted in the main frame 10 between the clamping segments 11, 12, 13 and the inserting element 20 is mounted in the earphone 91 of the portable electron device 90 via the limiting hole 16 of the mounting segment 14. Then, the cord 33 of the lock 30 is surrounded the post 80, and the body 31 of the lock 30 is mounted through the ring segment 331 of the cord 33 to enable the cord 33 to mount around the post 80. Later the rotating wheels 311 are rotated at the right position corresponding to secret code of the lock 30 to unlock the lock 30, and the controlling element 32 is pressed to enable the clamping segment 323 to move relative to the clamping arm 315 of the body 31. Then, the controller element 32 is un-pressed to mount the clamping arm 315 and the clamping segment 323 around the mounting segment 14 and the head segment 21 of the inserting element 20.

At this time, with reference to FIGS. 1 and 5 to 7, an elastic force of the compressed spring 313 will push the spindle 312 to move relative to the body 31 to move the protrusions of the spindle 312 in the non-circular holes of the rotating wheels 311. Then, the rotating wheels 311 can be rotated at random to enable the protrusions of the spindle 312 to abut against the sides of the rotating wheels 311. Consequently, the spindle 312 cannot be moved relative to the body 31 and the controlling element 32 cannot be pressed relative to the body 31, and this will enable the controlling element 32 and the body 31 to securely clamp the mounting segment 14 of the main frame 20 and to mount over and limit the inserting element 20. Additionally, the portable electron device 90 is securely mounted in the main frame 10 by the inserting element 20 and is also securely connected to the lock 30.

Furthermore, a cross-section area of the portable electron device 90 at any angle is larger than a diameter of the ring segment 331 of the cord, and the portable electron device 90 and the lock 30 cannot pass through the ring segment 331 of the cord 33. Therefore, the portable electron device can be fixed with the post 80 by the cord 33 of the lock 30 and cannot separate from the lock 30 or the post 80 and this can prevent the portable electron device 90 from being stolen when the portable electron device 90 is not taken with the user.

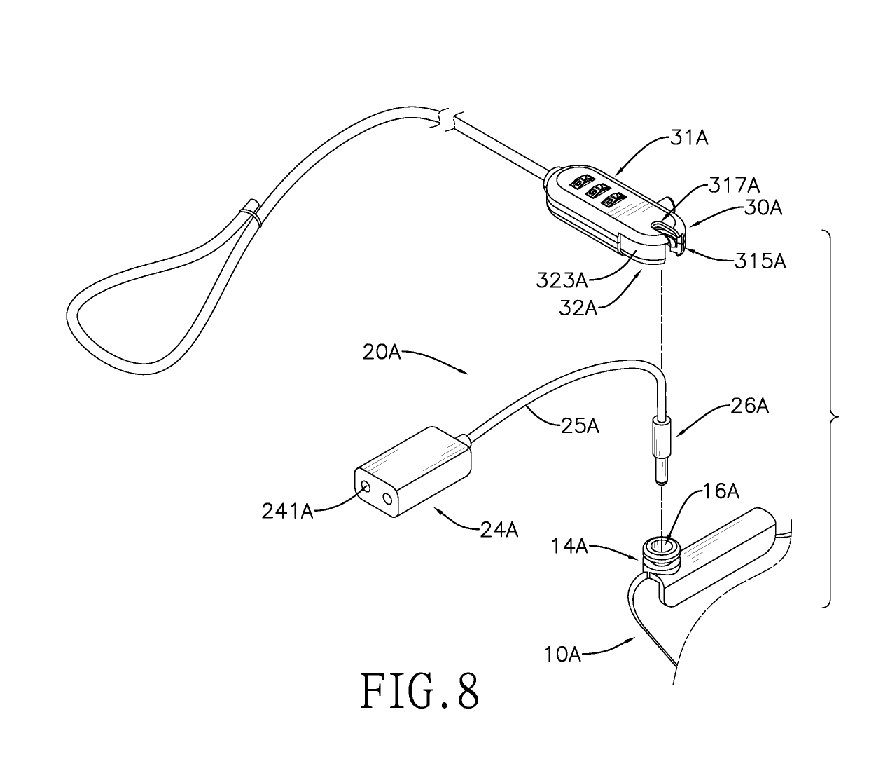

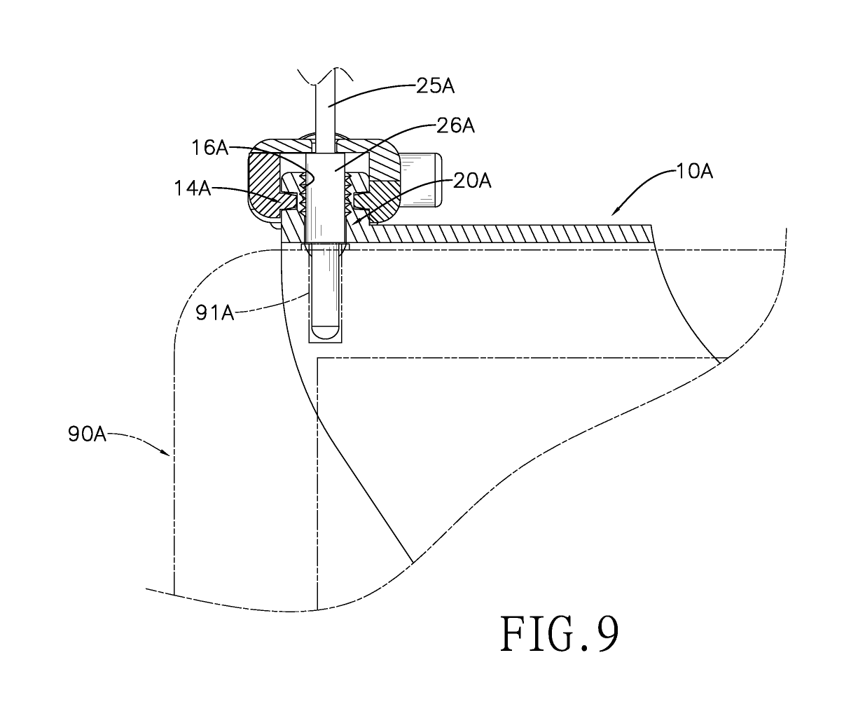

With reference to FIGS. 8 and 9, the second embodiment of a locking assembly for a portable electron device in accordance with the present invention has a structure substantially same as that in the first embodiment except that the inserting element 20A has an adapter 24A, a connecting line 25A and a connecting joint 26A and the body 31A has a second hole 317A. The adapter 24A has at least one earphone hole 241A and multiple electron components. The connecting line 25A is an electric wire and is connected to the adapter 24A. The connecting joint 26A is connected to the connecting line 25A, is mounted through the limiting hole 16A of the main frame 10A and is mounted in the earphone hole 91A of the portable electron device 90A. The second opening 317A is formed through the body 31A near the clamping end of the body 31A above the clamping opening between the clamping arm 315A and the clamping segment 323A and communicates with the clamping opening. With reference to FIG. 8, when the clamping arm 315A of the body 31A and the clamping segment 323A of the inserting element 32A are clamped with the mounting segment 14A of the main frame 10A and the connecting joint 26A of the inserting element 20A, the connecting line 25A extends out of the body 31A via the second opening 317A to connect with the adapter 24A.

Then, the user can inert an earphone in one of the at least one earphone hole 241A of the adapter 24A to communicate data from the portable electron device 90A by the connecting line 25A and the connecting joint 26A. Then, the user can use the at least one earphone hole 241A of the adapter 24A to substitute the earphone hole 91A of the portable electron device 90A and did not need to separate the inserting element 20A from the earphone hole 91A and this can prevent the earphone hole 91A of the portable electron device 90A from wearing.

In addition, the main frame 10, 10A may be a random shape and also can be a hard casing that is mounted on the portable electron device 90, 90A to limit the movement of the portable electron device 90, 90A. Preferably, the limiting hole 16, 16A may not have a thread and the inserting element 20, 20A can be securely mounted in the earphone 91, 91A of the portable electron device 90, 90A by the lock 30, 30A.

Furthermore, the recess 15 may be formed on the body 31, 31A or the controlling element 32, 32A of the lock 30, 30A, and the engaging flanges 316, 324 may formed on the external surface of the mounting segment 14, 14A to enable the body 31, 31A and the controlling element 32, 32A to securely clamp with the mounting segment 14, 14A and to connect the lock 30, 30A securely with the main frame 10, 10A.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A locking assembly for a portable electron device, having:
a main frame having:
a proximal end;
a distal end;
a first clamping segment curvedly formed on the proximal end of the main frame;
a second clamping segment curvedly formed on the distal end of the main frame;
a mounting segment formed on and protruding from a proximal end of the first clamping segment; and
a limiting hole formed through the mounting segment and the first clamping segment of the main frame;
an inserting element mounted through the limiting hole of the main frame; and
a lock mounted around the mounting segment and the inserting element and having:
a body mounted around the mounting segment;
a controlling element movably connected to the body to being set in a locked condition or an unlocked condition relative to the body; and
an extending element securely connected to the body opposite to the controlling element and having:
a connecting end securely connected to the body; and
a mounting end;
wherein, when the controlling element is set in a locked condition, the body and the controlling element engage the mounting segment of the main frame to limiting the movement of the inserting element.

2. The locking assembly as claimed in claim 1, wherein the body and the controlling element form a clamping opening to mount around the mounting segment of the main frame and the inserting element in a lock condition.

3. The locking assembly as claimed in claim 2, wherein
the limiting hole is threaded; and
the inserting element is screwed with the limiting hole of the main frame.

4. The locking assembly as claimed in claim 1, wherein
the inserting element has
an adapter having at least one earphone hole;
a connecting line connected to the adapter; and
a connecting joint connected to the connecting line and mounted through the limiting hole of the main frame; and
the body has a second opening formed through the body above and communicating with the clamping opening to enable the connecting line to extend out of the body.

5. The locking assembly as claimed in claim 3, wherein the extending element of the lock is a cord.

6. The locking assembly as claimed in claim 5, wherein the extending element has a ring segment formed on the mounting end of the extending element.

7. The locking assembly as claimed in claim 4, wherein the extending element has a ring segment formed on the mounting end of the extending element.

8. The locking assembly as claimed in claim 6, wherein the extending element has a ring segment formed on the mounting end of the extending element.

9. The locking assembly as claimed in claim 1, wherein the controlling element of the lock is moved linearly relative to the body to being set in a lock condition or an un-lock condition.

10. The locking assembly as claimed in claim 8, wherein the controlling element of the lock is moved linearly relative to the body to being set in a lock condition or an un-lock condition.

11. The locking assembly as claimed in claim 1, wherein
the mounting segment has an external surface and a recess formed around the external surface of the mounting segment;
the body has an engaging flange formed on and protruding from the body;
the controlling element has an engaging flange formed on and protruding from the controlling element;
wherein the controlling element is set in a lock condition, the engaging flanges of the body and the controlling element engage the recess to connect the lock securely with the main frame.

12. The locking assembly as claimed in claim 2, wherein
the mounting segment has an external surface and a recess formed around the external surface of the mounting segment;
the body has an engaging flange formed on and protruding from the body;
the controlling element has an engaging flange formed on and protruding from the controlling element;
wherein the controlling element is set in a lock condition, the engaging flanges of the body and the controlling element engage the recess to connect the lock securely with the main frame.

13. The locking assembly as claimed in claim 3, wherein
the mounting segment has an external surface and a recess formed around the external surface of the mounting segment;
the body has an engaging flange formed on and protruding from the body;
the controlling element has an engaging flange formed on and protruding from the controlling element;
wherein the controlling element is set in a lock condition, the engaging flanges of the body and the controlling element engage the recess to connect the lock securely with the main frame.

14. The locking assembly as claimed in claim 4, wherein
the mounting segment has an external surface and a recess formed around the external surface of the mounting segment;
the body has an engaging flange formed on and protruding from the body;
the controlling element has an engaging flange formed on and protruding from the controlling element;
wherein the controlling element is set in a lock condition, the engaging flanges of the body and the controlling element engage the recess to connect the lock securely with the main frame.

15. The locking assembly as claimed in claim 5, wherein
the mounting segment has an external surface and a recess formed around the external surface of the mounting segment;
the body has an engaging flange formed on and protruding from the body;
the controlling element has an engaging flange formed on and protruding from the controlling element;
wherein the controlling element is set in a lock condition, the engaging flanges of the body and the controlling element engage the recess to connect the lock securely with the main frame.

16. The locking assembly as claimed in claim 10, wherein
the mounting segment has an external surface and a recess formed around the external surface of the mounting segment;
the body has an engaging flange formed on and protruding from the body;
the controlling element has an engaging flange formed on and protruding from the controlling element;
wherein the controlling element is set in a lock condition, the engaging flanges of the body and the controlling element engage the recess to connect the lock securely with the main frame.

17. The locking assembly as claimed in claim 1, wherein the lock is a combination lock.

18. The locking assembly as claimed in claim 16, wherein the lock is a combination lock.
